(19) United States
(12) Patent Application Publication
(10) Pub. No.: US 2007/0030406 A1
(43) Pub. Date: Feb. 8, 2007

(54) Cathode ray tube of the index type

(75) Inventor: Willem Lubertus Ijzerman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/554,597

(22) PCT Filed: Apr. 27, 2004
(86) PCT No.: PCT/IB04/50518

§ 371 Date: Oct. 27, 2005

(30) Foreign Application Priority Data
May 1, 2003 (EP) 03101207.3

(51) Int. Cl. H01J 29/50; H04N 9/24

(52) U.S. Cl. 348/811; 313/409

(57) ABSTRACT

The invention is related to a cathode ray tube of the index type wherein the tracking structure allows the type to be used in progressive scan mode. The tracking structure comprises tracking elements (16,18) of a first kind and a second kind for generating a first response signal (S1) and a second response signal (S2), respectively, when hit by an electron beam of the tube, the first and the second response signals for determination of a positioning signal, and the tracking elements (16,18) parallel to the phosphor elements (20,20′,20″) whereby each phosphor element is flanked on either side by a tracking element of the first kind (16) and a tracking element of the second kind (18), respectively, except for each phosphor element of the third (B) color (2040″) of each third set (330), whereby each side of said phosphor element of the third (B) color is flanked by tracking elements of the same kind. This tracking structure has the advantage that the index tube has no noticeable flicker if operated in interlaced scan mode.

The invention relates to a cathode ray tube of the index type.

Cathode ray tubes of the index type operate without a shadow mask. An inner screen is provided with phosphor elements that extend in a direction, preferably the horizontal direction. Each phosphor element is flanked, preferably above and below, by tracking elements belonging to a tracking structure. Proper landing of the electron beam on the desired phosphor elements (conventionally the phosphors generate red, green and blue light) is assured by using a correction signal that contains information about the deviation of the electron beam from the ideal position on the phosphor element. The tracking elements comprise phosphors that excite light when being hit by the electron beam. The phosphors of the tracking elements positioned above the phosphor elements excite with a first wavelength and the phosphors of the tracking elements positioned below the phosphor elements excite with a second wavelength when being hit by the electron beam. The excited light is detected by two photo-detectors, a first detector being sensitive to the first wavelength, and a second detector being sensitive to the second wavelength. The signals from the two detectors are used to derive the correction signal for correcting the position of the electron beam in case it deviates from the ideal path over the phosphor element by means of a feedback loop that steers the beams to the center of the phosphor lines, thereby avoiding color errors.

It is a problem of the conventional index tube that the tube can only be used if driven in so-called progressive scan mode. It is desired that the tube may be used in so-called interlaced scan mode, which is also the mode of driving conventional cathode ray tubes. However, if the conventional index tube is driven in interlaced scan mode this results in a displayed image that has an unacceptable level of flicker.

It is an object of the invention to provide a cathode ray tube of the index type that can be driven in interlaced scan mode without any image flicker. To this end the cathode ray tube according to the invention is defined by independent claim 1. The dependent claims describe advantageous embodiments of the invention.

The invention is based on the insight that the tracking structure of the conventional index tube provides an error signal that alternates in sign between successively scanned phosphor lines. To reduce disturbances of the error signal it is necessary in the conventional index tube to average the error signal over the last two lines. For this averaging to be effective the relevant part of the error signal should change sign from phosphor line to phosphor line. If the conventional index tube structure is used in a progressive mode this sign change takes place. However, when used in interlaced mode, the sign change is absent and the tracking will result in a noticeable screen flicker.

In the tracking structure according to the invention the error signal alternates between successively scanned lines and the disturbances can be suppressed. Consequently no flicker is present if the tube is used in progressive mode.

These and other objects of the invention will be apparent from and elucidated with reference to the embodiments described hereinafter.

In the drawings:

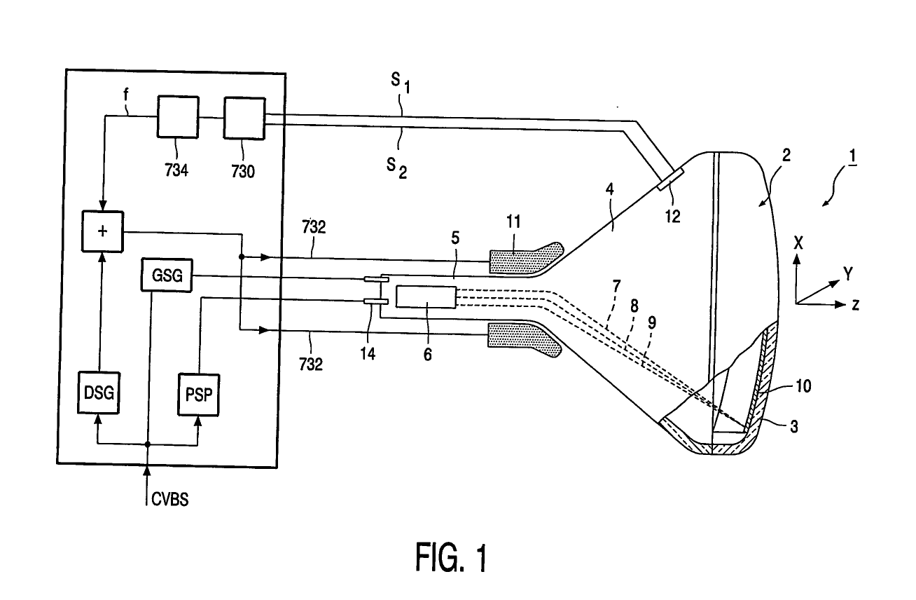

FIG. 1 shows a conventional CRT of the index type,

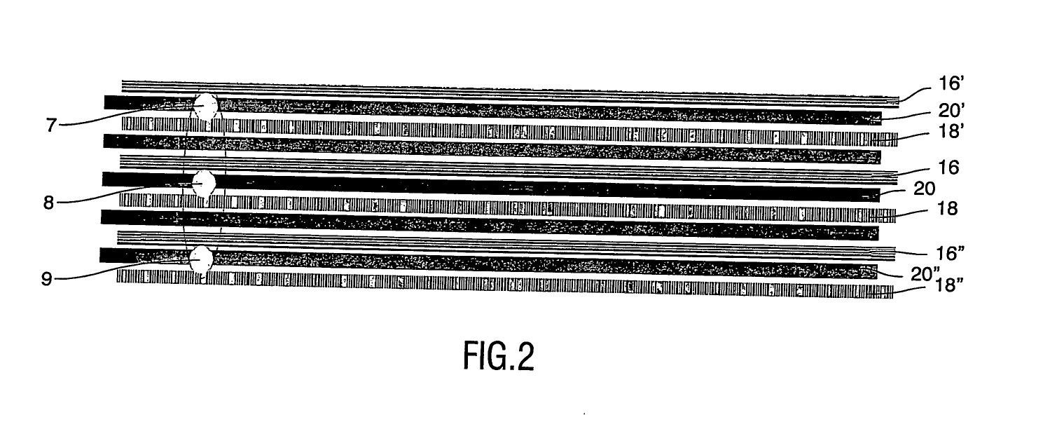

FIG. 2 shows a tracking structure of a conventional index type CRT,

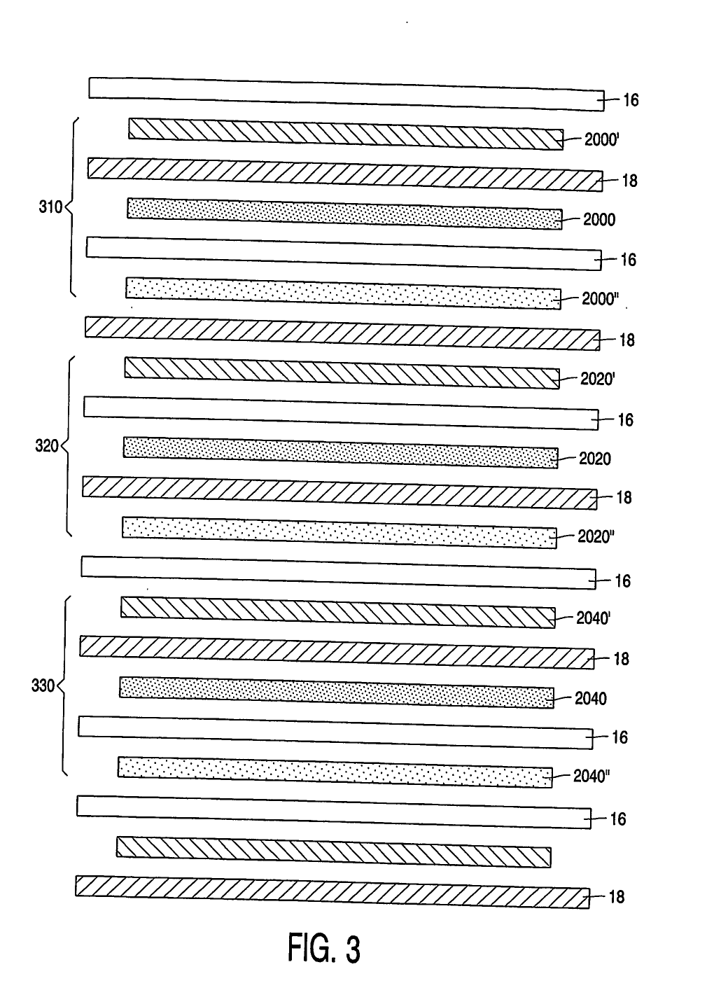

FIG. 3 shows an embodiment of a tracking structure according to the invention,

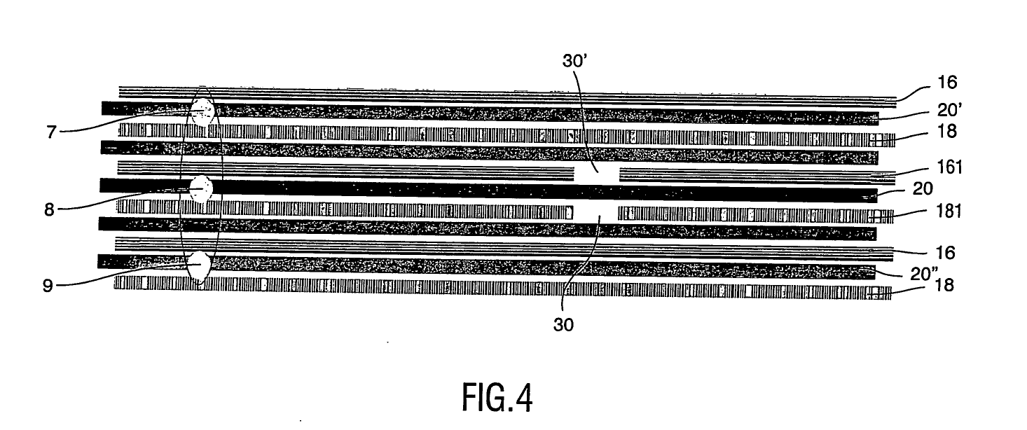

FIG. 4 shows a second embodiment of a tracking structure according to the invention, and

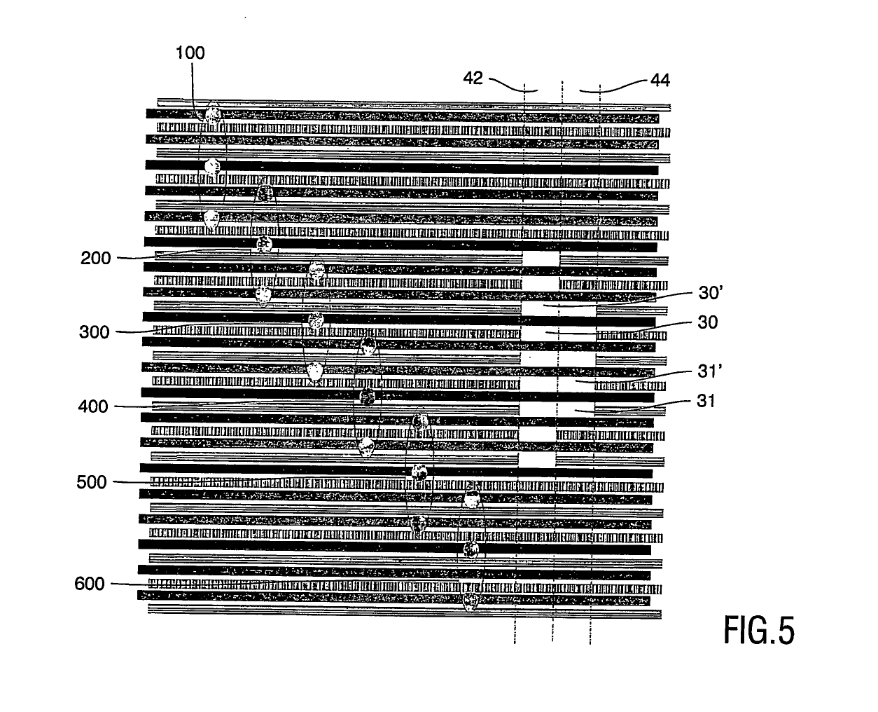

FIG. 5 shows a third embodiment of a tracking structure according to the invention.

The figures are not drawn to scale. In the figures, like reference numerals generally refer to like parts.

In FIG. 1, a display apparatus of a conventional index type color cathode ray tube 1 having an evacuated envelope 2 comprising a display window 3, a cone 4 and a neck 5. The neck 5 accommodates an electron gun 6 for generating electron beams 7, 8 and 9 extending, in this embodiment, in one plane, the in-line plane. In the in-plane configuration, there are two side beams and one central electron beam. A display screen 10 comprises a plurality of red, green and blue-luminescing phosphor elements. On their way to the display screen 10, the electron beams 7, 8 and 9 are deflected across the display screen 10 by means of a deflection unit 11.

The tube further comprises an element 12 from which a first response signal S1 and second response signal S2 are fed to a deflection correction generator 730 that generates a deflection correction signal ƒ based on the two response signals. A Composite Video Baseband Signal (CVBS, or a similar video input signal) is applied to a Deflection Signal Generator (DSG) for generating a deflection signal, a Picture Signal Processor (PSP) for generating a picture signal for gun 6 and a Grid Signal Generator (GSG) for generating a signal for grid elements 14. The deflection signal ƒ is combined with the deflection signal from the DSG and used as deflection signal 732 for the deflection unit 11.

For a three-electron beam the feedback mechanism comprises two subsystems, a slow and fast feedback loop. The fast feedback loop corrects disturbances that effect the landing position of all three beams simultaneously. In general these disturbances come from outside the tube and occur at relatively high frequencies. Examples are the electromagnetic fields induced by transformers of halogen lamps or the fields induced by mobile phones.

The fast loop corrects the landing position of all three beams by means of a magnetic dipole. This loop is able to correct for vertical displacements of the order of one phosphor line, larger displacements will result in tracking errors (i.e. tracking on the wrong phosphor line).

The slow feedback loop corrects (slow) disturbances that can effect the landing position of the individual beams. Examples of such disturbances are the astigmatism and coma errors from the deflection yoke. These errors change in time due to heating of the yoke. The time scales at which these changes occur are typically of the order of tens of minutes. The slow feedback loop corrects the landing position of the individual beams by means of coils that generate magnetic dipole-, quadrupole- and sextupole-fields.

The conventional cathode ray tube (hence the non-index CRT) is operated in so-called interlaced scan mode. In Europe a complete picture to be build up on the screen uses 625 picture lines (here phosphor triplets), which run from left to right and from top to bottom. A ‘fresh’ picture is written on the screen 25 times every second. First all ‘odd’ lines are scanned (written) to the bottom of the picture, then a quick jump back to the top of the screen takes place after which the intervening (‘even’) lines are scanned in the same way. The ivision into an even and an uneven half-frame is called interlaced scanning. Due to the way he error signal is constructed the conventional index tube cannot be operated in the above-described interlaced scan mode. Conventional index tubes are therefore operated in a progressive mode, i.e. the displayed picture is built-up of a full frame that is obtained by progressively scanning all lines.

FIG. 2 shows a detail of a tracking structure of a conventional cathode ray tube of the index type. The tracking structure is located on an inner surface of the screen 10, which has phosphor elements 20,20′,20″. Tracking elements 16 and 18 extend parallel (preferably horizontally, i.e. parallel to the x-axis) to the phosphor elements. Tracking elements 16 and 18 are positioned adjacent to phosphor element 20.

Simultaneously, the three electron beams 7,8,9 are scanned over the phosphor elements. Each beam scans over a phosphor element emitting either red light (in case of electron beam 7), green light (electron beam 8) or blue light (electron beam 9), thus forming a pixel element. For reasons of conciseness, the terms red, green and blue electron beam, respectively, will be used. When the electron beam, for example electron beam 8, hits the tracking element 16, which is located above the phosphor element 20, light of a first wavelength is emitted and registered by a first photo-detector located on or in the tube. Whereas when electron beam 8 hits the tracking element 18 located below the phosphor element 20 light of a second wavelength is emitted and registered by a second photo-detector. Electron beam 8 impinging on phosphor element 20 will also impinge on tracking elements 16 and 18. When the electron beam evenly impinges on tracking elements 16 and 18, there will be no difference in response signals from the tracking elements. When the electron beam is shifted upwards or downwards, more electrons will impinge on one of the tracking elements than on the other and a difference in response signals will occur. This difference can be measured and used for correcting the position of the electron beam 8 with respect to phosphor element 20.

The beams are separated from each other by one phosphor line. This is done to obtain a difference signal S1-S2 that has the same sign for all three beams, which allows to combine fast tracking of the average position of the three beams with a slow tracking of the position of the side beams with respect to the center beam. This way of tracking the beams is disclosed in WO02/093612.

In the conventional index tube a vertical average of the tracking signal is used to steer the beams over the right phosphor track. The disturbances are low frequent compared to the line frequency. Therefore the error signal on the j−1^{th} line is a good prediction of the error signal on the j^{th} line.

However, there is one complication with interlaced tubes: the error signal has a symmetric contribution. So, for odd numbered lines the error signal can be written as:
ε₁=αΔy+β
α is a constant, Δy the average vertical displacement of the beams and β a symmetric disturbance. This disturbance is the result of asymmetries in the amplifiers, detectors, etc. For the even lines the error signal reads:
ε₂=−αΔy+β

To remove the symmetric disturbance the error signal of two lines are subtracted and used as an error signal for the feedback:

$$\hat{ɛ} = \frac{1}{2} ( {ɛ}_{1} - {ɛ}_{2} ) = αΔ y$$

(Or the error signal of successive lines are used to get a larger time average and to suppress noise).

For a progressive index tube the above indicated averaging works. However, for an interlaced tube the averaging is not possible. For the odd (even) frames all error signals have the sane sign. So, there is no way in which the symmetric disturbance can be removed. Experiments have shown that a dramatic flicker is obtained if the symmetric disturbance is not removed.

FIG. 3 shows an embodiment of a tracking structure according to the invention.

The phosphor elements are grouped in sets of three 310,320,330. Each phosphor element 2000,2000′,2000″,2020,2020′,2020″,2040,2040′ is flanked on either side by a tracking element of the first kind 16 and a tracking element of the second kind 18, respectively, except for each third phosphor element 2040″ of each third set 330, whereby each side of said third phosphor element is flanked by tracking elements of the same kind, in this specific example a tracking element a tracking element of the first kind 16.

The tracking structure according to the invention is periodic over three phosphor triplets. If used in a progressive mode, the third and sixth line do not yield any useful feedback signal. For the first to sixth line the error signals read:
ε₁=αΔy+β
ε₂=−αΔy+β
ε₄=αΔy+β
ε₅=−αΔy+β
An estimation of the tracking signal for the third and the sixth line can be obtained by extrapolation.

In an interlaced mode the second and the third line are not observable in the odd and even frames respectively. So, in the even frame the error signals read:
ε₁=αΔy+β
ε₃=−αΔy+β
and in the odd frames:
ε₁′=αΔy+β
ε₂′=αΔy+β
Here as well by a proper linear combination of previous error signals an extrapolation to estimate the missing lines can be made.

FIG. 4 shows a further embodiment of a tracking structure according to the invention. In this embodiment a subset of the tracking elements 161,181 have gaps 30,30′ for deriving an additional positioning signal for positioning the electron beam. By providing a subset of the tracking elements with gaps a temporary interruption of the correction signal is generated, when the electron beam is at a well defined position of the screen. This interruption is additionally used to control the electron beam, in particular during the start-up period of the television set.

FIG. 5 shows a further advantageous embodiment of the invention. Gaps 30,30′ of m adjacent phosphor elements form part of a first column 42, and gaps 31,31′ of n adjacent phosphor elements form part of a second column 44. Both columns extend in a direction perpendicular to the tracking elements. The first 42 and the second column 44 are positioned adjacent to each other. In the example shown in FIG. 5 m is equal to nine and n is equal to five, while the first and the second column are positioned symmetrically with respect to each other, i.e. centers of the columns are positioned on the same phosphor element. In view of its shape, this structure is also called T-structure.

The purpose of the first column (which is scanned first in time, as scanning in this example takes place from left to right) is to provide a start-of-structure signal, that can be detected even when the macroscopic correction is completely wrong.

If the tracking of the electron beams is good, only the scanning of four scan lines is influenced by this structure (in one scan three beams are scanned along three phosphor lines, four of these scans are affected). The three beams at positions 100 and 600 will miss the structure. The three beams at positions 200 and 500 will be negatively influenced by the structure; in the first column 42 of the structure. At both positions the green beam (i.e. the middle) will hit only one of the two tracking elements, so the tracking signal can temporarily not be used.

At positions 300 and 400 the electron beams hit the first column 42 of the structure; there will be no tracking signal at all. This condition allows a reliable detection of the start of the structure, even when life video is shown. In the second column 44, the tracking signal will come from only the red beam in case of position 300, and only from the blue beam in case of position 400.

The embodiment of the invention shown in FIG. 5 has additional advantages related to raster correction, convergence and focus of the electron beam. These advantages will be explained hereinafter.

Raster Correction

If the tracking is wrong, the first column of the structure can still be detected quite easily. Therefore, getting the macroscopic tracking aspects of the tracking right is greatly simplified by the presence of this structure. During the calibration phase, a uniform green test pattern can be displayed. The photo-detectors will generate a signal in which the structures are easily detectable. Pattern matching algorithms produce position information with a resolution better than one phosphor line. This gives immediate absolute horizontal and vertical position information about the scanned raster, and thus control settings of the tube like width, height, linearity etc can easily be adjusted.

As information is required from all screen areas, a large number of these T-structures is required. They can be placed on the positions of a x by y-matrix that covers the whole screen. The ideal number and horizontal width of these positions depend on a large number of aspects, such as: bandwidth of the optical detection mechanism, horizontal spot size and maximum correctable misalignment, etc.

A matrix of 9 by 9 T-structures has proved to be a practical value.

Convergence

Convergence can be measured at the position of the T-structure, without special requirements on the video contents, other than that it should not be completely black. Assuming that the macroscopic position is correct, and that the microscopic tracking keeps the combined three beams on track, the structures provide convergence information in the second column, which allow the red and blue side beams to be adjusted so that the vertical distance between the three beams is correct.

In the area outside the structure, the measured tracking signal is a weighted average of the contribution of the red, green and blue beams. The weight is dependent of the video contents, and therefore not controlled by the tracking system itself. However, in the second column of the structure, the beams at position 300 in FIG. 4 will generate a tracking signal which only depends on the red beam, and at position 400 only depends on the blue beam. If there is a difference between the weighted signal from red, green and blue, and the signal that is only dependent on red, it is clear that the red side beam is off-track. How much off-track can not be determined, as the video information can differ between these two measurements. But the sign of the difference signal is always correct, and can be used to adjust the red side beam in small steps into the proper direction. This is a proper method, as convergence errors have a slow drift behavior. In order to prevent images that do not contain red at the position of the structure, the adjustments must not be performed when the measured signal drops below a specific threshold value. The same method is to be applied to the blue beam.

The advantage of this method is that it can be performed during operation of the tube, not only within the start-up phase of the television set, and without visible interference.

Focus

A global focus adjustment can be performed by minimizing the signal level that is generated by the two tracking phosphors: the better the spot size in the vertical direction, the lower the number of electrons hitting tracking phosphors. In the conventional tracking structure, only the combined focus can be judged, and the contributions per color depend on the video content shown. (a situation similar to that of the position error described above).

The above structures allow the focus of the red and blue beam to be measured separately, greatly simplifying the adjustment of the focus of all three beams.

In summary, the invention is related to a cathode ray tube of the index type wherein the tracking structure allows the type to be used in progressive scan mode. The tracking structure comprises tracking elements of a first kind 16 and a second kind 18 for generating a first response signal S1 and a second response signal S2, respectively, when hit by an electron beam of the tube, the first and the second response signals for determination of a positioning signal, and the tracking elements 16,18 extending parallel to the phosphor elements 2000,2000′,2000″,2020,2020′,2020″, 2040,2040′,2040″ whereby each phosphor element is flanked on either side by a tracking element of the first kind 16 and a tracking element of the second kind 18, respectively, except for each phosphor element of the third B color 2040″ of each third set 330, whereby each side of said phosphor element of the third B color is flanked by tracking elements of the same kind. This tracking structure has the advantage that the index tube has no noticeable flicker if operated in interlaced scan mode.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of other elements or steps than those listed in a claim. The word “a” or “an” preceding an element does not exclude the presence of a plurality of such elements.

1. A cathode ray tube (1) of the index type comprising:
a gun (6) for generating an electron beam (7,8,9),
means (11) for deflecting the electron beam (7,8,9) across an inner surface of a screen (10),
response means for controlling the deflection in response to a positioning signal,
the screen being provided with phosphor elements (2000,2000′,2000″,2020,2020′,2020″, 2040,2040′,2040″) for generating light when being excited by the electron beam, the phosphor elements being grouped in sets of three phosphor elements (310,320,320) that emit a first (R), a second (G) and a third color (B) of light, respectively, when excited,
the screen (10) further being provided with tracking elements of a first kind (16) and a second kind (18) for generating a first response signal (S1) and a second response signal (S2), respectively, when hit by the electron beam, the first and the second response signals for determination of a positioning signal, and
the tracking elements (16,18) extending parallel to the phosphor elements whereby each phosphor element is flanked on either side by a tracking element of the first kind (16) and a tracking element of the second kind (18), respectively, except for each phosphor element (2040″) of the third (B) color of each third set (330), whereby each side of said phosphor element of the third (B) color is flanked by tracking elements of the same kind (16).

2. A cathode ray tube of the index type according to claim 1, wherein a subset of the tracking elements (16,18) have gaps (30,30′) for deriving an additional positioning signal for positioning the electron beam (7,8,9).

3. A cathode ray tube of the index type according to claim 1, wherein gaps (30,30′) of m adjacent phosphor elements form a first column (42) and gaps (31,31′) of n adjacent phosphor elements form a second column (44), both columns (42,44) extending in a direction perpendicular to the tracking elements (20), the first (42) and the second (44) column being positioned adjacent to each other.

4. A cathode ray tube of the index type according to claim 3, wherein m is equal to nine and n is equal to five, while the first (42) and the second (44) column are positioned symmetrically with respect to each other.

5. A cathode ray tube of the index type according to claim 4, wherein the first and the second column form a T-structure, and the inner surface of the screen is provided with a set of T-structures that are distributed over the screen according to the positions of a x by y-matrix.

6. A cathode ray tube of the index type according to claim 5, wherein x and y are equal to nine.

7. A television system provided with the cathode ray tube according to claim 1, wherein the television system comprises means for providing a control signal based on the first (S1) and second (S2) response signals.
